(19) United States
(12) Patent Application Publication
(10) Pub. No.: US 2014/0376256 A1
(43) Pub. Date: Dec. 25, 2014

(54) LIGHT SOURCE MODULE

(71) Applicant: Young Lighting Technology Inc., Hsin-Chu (TW)

(72) Inventors: YI- WEN LIN, Hsin-Chu (TW); JUNG-HAO CHEN, Hsin-Chu (TW); DER-WOEI HSAIO, Hsin-Chu (TW)

(73) Assignee: Young Lighting Technology Inc., Hsin-Chu (TW)

(21) Appl. No.: 14/300,814

(22) Filed: Jun. 10, 2014

(30) Foreign Application Priority Data
Jun. 24, 2013 (TW) 102122391

(51) Int. Cl. F21V 8/00

(52) U.S. Cl. CPC G02B 6/0085; G02B 6/0068; G02B 6/0031
USPC 362/606; 362/613

(57) ABSTRACT

A light source module includes a light guide plate, at least one light emitting element, a circuit board, and a heat conductive structure. The light guide plate has a light incident surface and a bottom surface adjacent to each other. The light emitting element is disposed beside the light incident surface. The circuit board has a bottom and a sidewall. The bottom extends toward the light guide plate from an end of the sidewall. The sidewall has a first surface facing the light incident surface, and the bottom has a second surface facing the bottom surface. The light emitting element is disposed on the first surface. The heat conductive structure is disposed on the circuit board contacted the first surface and the second surface of the circuit board, for transmitting heat generated by the light emitting element and the circuit board.

### FIELD OF THE INVENTION

The invention relates to a light source module, and more particularly to a light source module having a heat conductive structure.

### BACKGROUND OF THE INVENTION

A light emitting diode (LED) light bar is used in a backlight module as a light source. The LED light bar is made by adhering multiple LEDs to a circuit board by surface mounting technology (SMT). The LED light bar is attached to a side of a back plate by a screw or a thermal tape. Then, a reflective sheet is adhered on the LED light bar for reflecting light so as to increase the optical efficiency of the backlight. Finally, components including films and a plastic frame etc. are assembled to form the backlight module.

Only 15-20% of electrical energy consumed by LED during operation is converted into optical energy, the remaining 80-85% is converted into heat. Therefore, if too much waste heat accumulates in the backlight module, the temperature of the LED rises locally. This leads to problems such as a decrease in light-emitting efficiency, a chromaticity shift, and a lifetime decay of the LED.

Heat generated by the heat source of LED is mainly transmitted to L-shaped metal heat dissipation sheets disposed on sides of the back plate and on the back plate through a metal core print circuit board (MCPCB). Heat is then transmitted to elements such as the back plate or the plastic frame through heat absorption and thermal diffusion by the L-shaped metal heat dissipation sheets. Finally, the waste heat is dissipated by thermal convection with cold outside air. Moreover, in order to increase efficiency of thermal conduction, a thermal tape is usually used between the MCPCB and the metal heat dissipation sheets.

However, it is necessary to reduce the width of the plastic frame due to the recent trend of narrow frame design of the backlight module. The frame is thick because the thickness of the frame is constituted by the LED, the MCPCB, thermal tape, one end of the L-shaped metal heat dissipation sheet, and the side of the back plate. This leads to the difficulty of effectively reducing the width of the plastic frame.

### SUMMARY OF THE INVENTION

The invention provides a light source module with a reduced thickness of the heat dissipation structure. In this way, the demand for the narrow frame is met.

Other object and advantage of the invention can be understood by the following description of the technical features of the invention. In order to achieve at least one of the objects or other objects, an embodiment of the invention provides a light source module including a light guide plate, at least one light emitting element, a circuit board, and a heat conductive structure. The light guide plate has a light incident surface and a bottom surface adjacent to each other. The at least one light emitting element is disposed beside the light incident surface of the light guide plate. The circuit board has a bottom and a sidewall, the bottom extends toward the light guide plate from an end of the sidewall, the sidewall has a first surface facing the light incident surface of the light guide plate, the bottom has a second surface facing the bottom surface of the light guide plate, and the light emitting element is disposed on the first surface. The heat conductive structure is disposed on the circuit board contacted the first surface and the second surface of the circuit board, for transmitting heat generated by the light emitting element and the circuit board.

In an embodiment of the invention, the heat conductive structure has a top surface, a bottom surface, and a first lateral surface, the top surface is opposite to the bottom surface, the first lateral surface is adjacent to the top surface and the bottom surface contacted the first surface of the circuit board, the bottom surface is contacted the second surface of the circuit board

In an embodiment of the invention, the light source module further includes a back plate, the circuit board further includes a third surface opposite to the second surface, and the back plate is disposed on the third surface of the circuit board.

In an embodiment of the invention, the light source module further includes an electrical connector disposed on the third surface of the circuit board, for electrically connecting with a light source driver and the at least one light emitting element.

In an embodiment of the invention, the light source module further includes a back plate, the heat conductive structure further includes a second lateral surface opposite to the first lateral surface, and the back plate is disposed on the second lateral surface of the heat conductive structure.

In an embodiment of the invention, the sidewall and bottom are substantially L-shaped.

In an embodiment of the invention, the heat conductive structure includes a plate body, a first extension portion, and a second extension portion. The plate body has a top surface, a bottom surface, and a first lateral surface, the top surface is opposite to the bottom surface, and the first lateral surface is adjacent to the top surface and the bottom surface. The first extension portion extends from the top surface toward the first surface of the circuit board from an end of the plate body. The second extension portion extends from the bottom surface toward the first surface of the circuit board from the end of the plate body, the second extension portion and the first extension portion is opposite to each other, wherein the plate body, the first extension portion, and the second extension portion form an accommodating space for accommodating the bottom of the circuit board, and the first extension portion is contacted the first surface and the second surface of the circuit board, the circuit board further includes a third surface opposite to the second surface, and the second extension portion is contacted the third surface.

In an embodiment of the invention, the light source module further includes a back plate, the heat conductive structure is disposed on the back plate, and the back plate is contacted the plate body and the second extension portion of the heat conductive structure.

In an embodiment of the invention, the heat conductive structure includes a plate body and an extension portion. The extension portion extends toward the first surface of the circuit board from an end of the plate body, the extension portion and the plate body form an accommodating space for accommodating the bottom of the circuit board, and the extension portion is contacted the first surface and the second surface of the circuit board.

In an embodiment of the invention, the light source module further includes a back plate, the circuit board and the heat conductive structure are disposed on the back plate, the circuit board further includes a third surface opposite to the second surface, and the back plate is contacted the third surface of the circuit board and the plate body of the heat conductive structure.

In an embodiment of the invention, a thickness of the extension portion of the heat conductive structure is smaller than a thickness of the plate body of the heat conductive structure.

In an embodiment of the invention, a distance between the light emitting element and the bottom of the circuit board is D, the light emitting element has a height of H, and D ranges between 2H and 4H.

In an embodiment of the invention, the light source module further includes a supporting portion, at least one optical film and a reflective sheet. The supporting portion is disposed on the light guide plate. The at least one optical film is disposed between the supporting portion and the light guide plate. The reflective sheet is disposed between the light guide plate and the heat conductive structure.

In an embodiment of the invention, the circuit board includes a metal base material and a circuit layer, and the metal base material includes copper or aluminum.

In the light source module according to an embodiment of the invention, the circuit board includes a bottom and a sidewall, the bottom extends toward the light guide plate from an end of the sidewall. Specifically, the bottom and the sidewall of the circuit board are substantially L-shaped. The heat conductive structure is disposed on the circuit board contacted the sidewall and the bottom of the circuit board. In this structure, a contact area between the heat conductive structure and the circuit board is largely increased, and thus the heat dissipation efficiency is improved such that heat generated by the light emitting element and the circuit board can be easily removed. Further, in the heat conductive structure according to an embodiment of the invention, the width of the plastic frame could be effectively reduced by using the combination of the back plate and the circuit board, and thus the demand for a narrow frame could be met.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The invention will become more readily apparent to those ordinarily skilled in the art after reviewing the following detailed description and accompanying drawings, in which:

FIG. 1 is a cross-section diagram showing a light source module according to one embodiment of the invention.

FIG. 2A is a cross-section diagram showing a light source module according to another embodiment of the invention.

FIG. 2B is a cross-section diagram showing a light source module according to another embodiment of the invention.

FIG. 3 is a cross-section diagram showing a light source module according to another embodiment of the invention.

FIG. 4 is a cross-section diagram showing a light source module according to another embodiment of the invention.

FIG. 5 is a cross-section diagram showing a light source module according to another embodiment of the invention.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

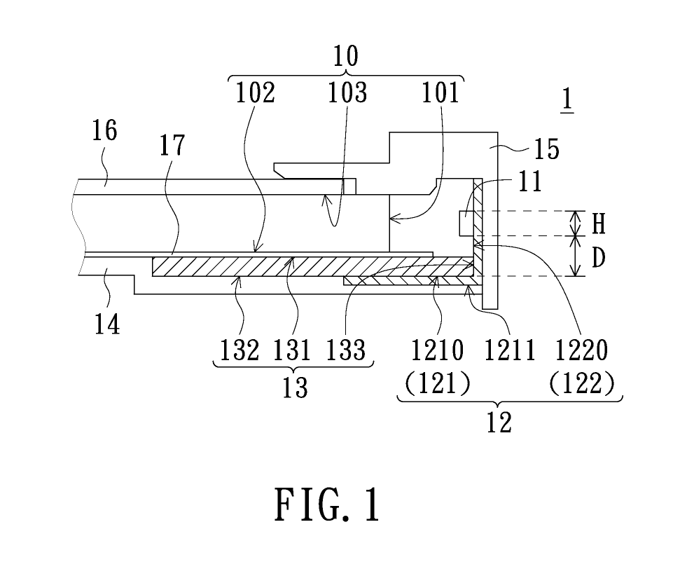

FIG. 1 is a cross-section diagram showing a light source module according to an embodiment of the invention. Referring to FIG. 1, the light source module 1 of the embodiment includes a light guide plate 10, at least one light emitting element 11, a circuit board 12, and a heat conductive structure 13. The light guide plate 10 has a light incident surface 101 and a bottom surface 102 adjacent to each other, and a light exit surface 103 opposite to the bottom surface 102. The light emitting element 11 is disposed beside the light incident surface 101 of the light guide plate 10. For example, the light emitting element 11 is but not limited to a light emitting diode (LED). The circuit board 12 has a bottom 121 and a sidewall 122. The bottom 121 of the circuit board 12 extends toward the light guide plate 10 from an end of the sidewall 122. Specifically, the bottom 121 and the sidewall 122 of the circuit board 12 are substantially L-shaped. The sidewall 122 of the circuit board 12 has a first surface 1220, and the bottom 121 of the circuit board 12 has a second surface 1210. The first surface 1220 of the circuit board 12 faces the light incident surface 101 of the light guide plate 10, while the second surface 1210 of the circuit board 12 faces the bottom surface 102 of the light guide plate 10. The light emitting element 11 is disposed on the first surface 1220 of the circuit board 12. The heat conductive structure 13 is disposed on the circuit board 12 contacted the first surface 1220 and the second surface 1210 of the circuit board 12, for example, the heat conductive structure 13 is disposed on the bottom 121 of the circuit board 12 contacted the first surface 1220 and the second surface 1210 of the circuit board 12. The heat conductive structure 13 is provided for transmitting heat generated by the light emitting element 11 and the circuit board 12.

The heat conductive structure 13 of the light source module 1 of the embodiment has a top surface 131, a bottom surface 132, and a lateral surface 133. The top surface 131 of the heat conductive structure 13 is opposite to the bottom surface 132, and the lateral surface 133 is adjacent to the top surface 131 and the bottom surface 132. Specifically, the lateral surface 133 of the heat conductive structure 13 is contacted the first surface 1220 of the circuit board 12, while the bottom surface 132 of the heat conductive structure 13 is contacted the second surface 1210 of the circuit board 12. In this embodiment, a distance between the light emitting element 11 and the bottom 121 of the circuit board 12 is set to be D, and the distance D ranges between 2 to 4 times of a height H of the light emitting element 11. A bending process is performed to the circuit board 12 in the manufacturing process of the light source module 1, if the light emitting element 11 is damaged due to the circuit board 12 pressing the light emitting element 11, the production yield rate of the light source module 1 will decrease. Here, the distance D between the light emitting element 11 and the bottom 121 of the circuit board 12 could prevent the damage of the light emitting element 11 during the bending process of the circuit board 12. Moreover, the circuit board 12 of the embodiment could further include a metal base material and a circuit layer (not shown). For example, the metal base material is but not limited to copper or aluminum.

The light source module 1 of the embodiment further includes a back plate 14. The circuit board 12 further includes a third surface 1211 opposite to the second surface 1210, wherein the second surface 1210 and the third surface 1211 are two opposite surfaces of the bottom 121 of the circuit board 12. The back plate 14 is disposed on the third surface 1211 of the circuit board 12. For example, the back plate 14 is disposed under the bottom 121 of the circuit board 12. In other words, the bottom 121 of the circuit board 12 is located between the heat conductive structure 13 and the back plate 14. By this configuration that the bottom 121 of the circuit board 12 is contacted the heat conductive structure 13 and the back plate 14, respectively, heat generated by the light emitting element 11 and the circuit board 12 during operation could be transmitted to the heat conductive structure 13 and the back plate 14 at the same time. Thus, the heat-transmitting efficiency is largely increased such that the problem of waste heat accumulation could be solved. In addition, the heat conductive structure 13 and the back plate 14 of the embodiment could be both in, for example, a plate shape (that is, without a side portion). Therefore, since the thickness of the frame is constituted by the light emitting element 11 and the sidewall 122 of the circuit board 12, the width of the plastic frame could be effectively reduced comparing to a conventional structure, and thus the demand for a narrow frame could be met. Moreover, the light source module 1 of the embodiment further includes a supporting portion 15, at least one optical film 16, and a reflective sheet 17. The supporting portion 15 is disposed on the light guide plate 10. The optical film 16 is disposed between the supporting portion 15 and the light guide plate 10. The optical film 16 is, for example, a concentrator film, a diffuser film, a hybrid optical film, or a combination of the above-mentioned films. The reflective sheet 17 is disposed between the light guide plate 10 and the heat conductive structure 13. Specifically, the reflective sheet 17 is disposed on the top surface 131 of the heat conductive structure 13. The detailed description for the supporting portion 15, the optical film 16, and the reflective sheet 17 will be omitted here.

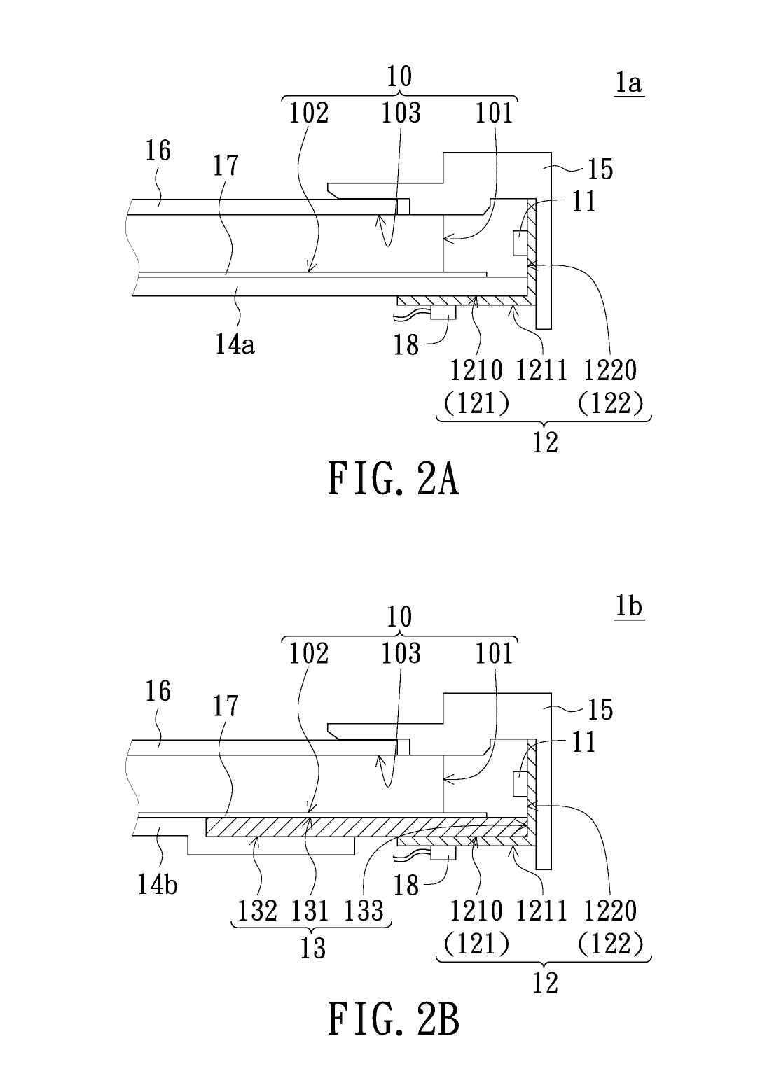

FIG. 2A is a cross-section diagram showing a light source module according to another embodiment of the invention. Referring to FIG. 2A, the light source module 1a of the embodiment is similar to the light source module 1 shown in FIG. 1. The difference is that the light source module 1a is configured without the heat conductive structure 13 shown in FIG. 1. That is, the back plate 14a of the embodiment also has a function of the heat conductive structure 13 shown in FIG. 1, that is, the back plate 14a has both functions of support and heat conduction. It is worth to mention that the light source module 1a of the embodiment further includes an electrical connector 18. In combination with the light source module 1a of the embodiment, the electrical connector 18 is disposed on, for example, the third surface 1211 of the circuit board 12, for electrically connecting with a light source driver (not shown) and the light emitting element 11. It should be noted that although the light source module 1a of the embodiment includes only the back plate 14a but not the heat conductive structure 13, it is merely an embodiment of the invention. Referring to FIG. 2B, a light source module 1b according to another embodiment could include a back plate 14b and the heat conductive structure 13 so as to increase the heat conduction efficiency.

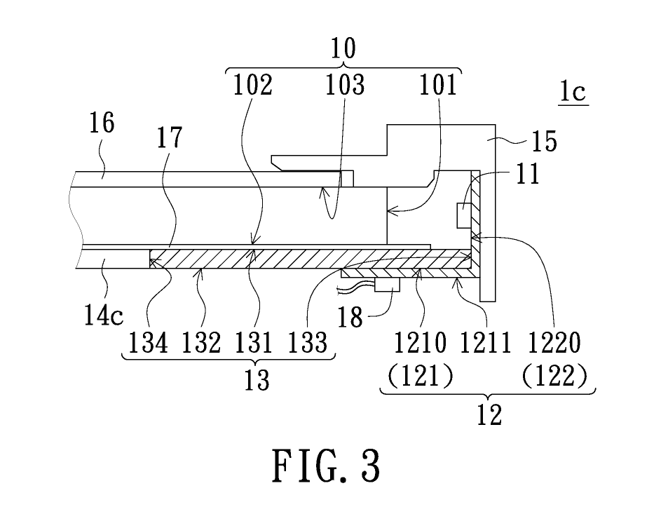

FIG. 3 is a cross-section diagram showing a light source module according to another embodiment of the invention. Referring to FIG. 3, the light source module 1c of the embodiment is similar to the light source module 1 shown in FIG. 1. The difference is that the heat conductive structure 13 further includes a lateral surface 134 opposite to the lateral surface 133, and the back plate 14c of the light source module 1c is disposed on the lateral surface 134 opposite to the lateral surface 133 of the heat conductive structure 13. By disposing the back plate 14c on the lateral surface 134 opposite to the lateral surface 133 of the heat conductive structure 13, the overall thickness of the light source module 1c could be further reduced. In addition, similar to the light source module 1a shown in FIG. 2A, in the light source module 1c of the embodiment, the electrical connector 18 could be on disposed on the third surface 1211 of the circuit board 12, for connecting with a light source driver (not shown).

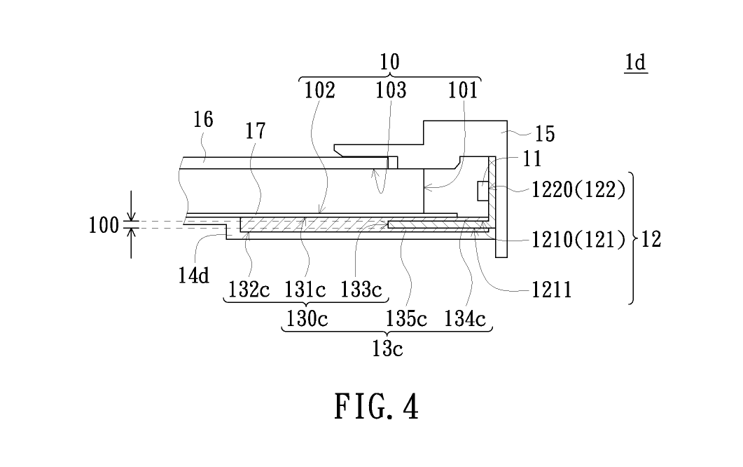

FIG. 4 is a cross-section diagram showing a light source module according to another embodiment of the invention. Referring to FIG. 4, a light source module 1d of the embodiment is similar to the light source module 1 shown in FIG. 1. The difference is that the heat conductive structure 13c of the light source module 1d includes a plate body 130c, a first extension portion 134c, and a second extension portion 135c. The plate body 130c has a top surface 131c, a bottom surface 132c, and a lateral surface 133c. The top surface 131c is opposite to the bottom surface 132c, and the lateral surface 133c is adjacent to the top surface 131c and the bottom surface 132c. The first extension portion 134c extends from the top surface 131c toward the first surface 1220 of the circuit board 12 from an end of the plate body 130c. The second extension portion 135c extends from the bottom surface 132c toward the first surface 1220 of the circuit 12 from the end of the plate body 130c. The first extension portion 134c and the second extension portion 135c are opposite to each other. The plate body 130c, the first extension portion 134c, and the second extension portion 135c form an accommodating space 100, for accommodating the bottom 121 of the circuit board 12. The first extension portion 134c is contacted the first surface 1220 and the second surface 1210 of the circuit board 12. The second extension portion 135c is contacted the third surface 1211 of the circuit board 12.

The bottom 121 of circuit board 12 according to the embodiment is accommodated in the accommodating space 100 encompassed by the first extension portion 134c and the second extension portion 135c of the heat conductive structure 13c, and the first extension portion 134c and the second extension portion 135c are contacted the first surface 1220, the second surface 1210, and the third surface 1211 of the circuit board 12, respectively. In this structure, the contact area between the circuit board 12 and the heat conductive structure 13c is large, so that the heat-transmitting efficiency is largely increased. Further, by disposing the heat conductive structure 13c on the back plate 14d, since the back plate 14d contacts the plate body 130c and the second extension portion 135c of the heat conductive structure 13c, heat generated by the light emitting element 11 and the circuit board 12 during operation is transmitted to outside of the light source module 1d through the back plate 14d. By this way, the problem of waste heat accumulation could be solved.

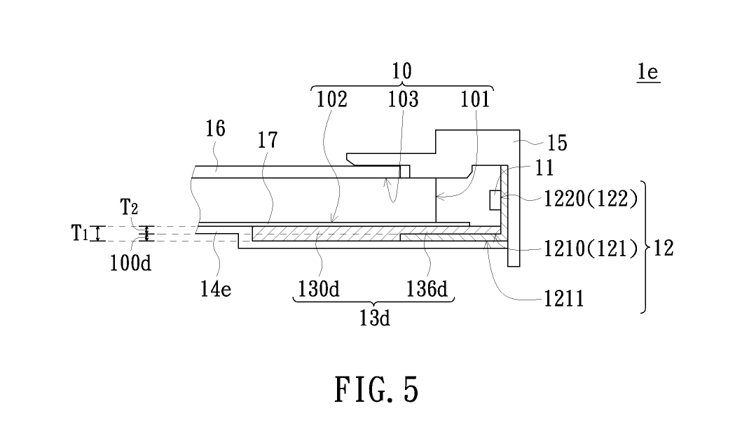

FIG. 5 is a cross-section diagram showing a light source module according to another embodiment of the invention. Referring to FIG. 5, the light source module 1e of the embodiment is similar to the light source module 1d shown in FIG. 4. The difference is that the heat conductive structure 13d of the light source module 1e includes a plate body 130d and an extension portion 136d. A thickness T₂ of the extension portion 136d, for example, is smaller than a thickness T₁ of the plate body 130d, but this does not limit the invention. The extension portion 136d extends toward the first surface 1220 of the circuit board 12 from an end of the plate body 130d. The extension portion 136d and the plate body 130d form an accommodating space 100d, for accommodating the bottom 121 of the circuit board 12. The extension portion 136d is contacted the first surface 1220 and the second surface 1210 of the circuit board 12. Moreover, the heat conductive structure 13d and the circuit board 12 of the embodiment are disposed on a back plate 14e. The bottom 121 of the circuit board 12 is located between the extension portion 136d of the heat conductive structure 13d and the back plate 14e. The back plate 14e is contacted the third surface 1211 of the circuit board 12 and the plate body 130d of the heat conductive structure 13d. By the structure of the light source module 1e according to the embodiment, the thermal conduction efficiency could be largely increased. Thus, heat generated by the light emitting element 11 and the circuit board 12 during operation can be transmitted to outside of the light source module 1e through the back plate 14e. By this way, the problem of waste heat accumulation could be solved.

In summary, the light source module of the invention embodiment has at least one of the following advantages. The circuit board includes a bottom and a sidewall, and the bottom extends toward the light guide plate from an end of the sidewall. Specifically, the bottom and the sidewall of the circuit board are substantially L-shaped. The heat conductive structure is disposed on the circuit board contacted the sidewall and the bottom of the circuit board. In this structure, the contact area between the heat conductive structure and the circuit board is largely increased, and the heat dissipation efficiency is improved. Thus, heat generated by the light emitting element and the circuit board could be easily removed. Further, in the heat conductive structure according to an embodiment of the invention, the width of the plastic frame could be effectively reduced by using the combination of the back plate and the circuit board, and thus the demand for a narrow frame could be met.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
a light guide plate, having a light incident surface and a bottom surface adjacent to each other;
at least one light emitting element, disposed beside the light incident surface of the light guide plate;
a circuit board, having a bottom and a sidewall, the bottom extending toward the light guide plate from an end of the sidewall, the sidewall having a first surface facing the light incident surface of the light guide plate, the bottom having a second surface facing the bottom surface of the light guide plate, and the light emitting element being disposed on the first surface; and
a heat conductive structure, disposed on the circuit board contacted the first surface and the second surface of the circuit board, for transmitting heat generated by the light emitting element and the circuit board.

2. The light source module according to claim 1, wherein the heat conductive structure has a top surface, a bottom surface, and a first lateral surface, the top surface is opposite to the bottom surface, the first lateral surface is adjacent to the top surface and the bottom surface contacted the first surface of the circuit board, the bottom surface is contacted the second surface of the circuit board.

3. The light source module according to claim 2, further comprising a back plate, the circuit board further comprising a third surface opposite to the second surface, and the back plate being disposed on the third surface of the circuit board.

4. The light source module according to claim 3, further comprising an electrical connector disposed on the third surface of the circuit board, for electrically connecting with a light source driver and the at least one light emitting element.

5. The light source module according to claim 2, further comprising a back plate, the heat conductive structure further comprising a second lateral surface opposite to the first lateral surface, and the back plate being disposed on the second lateral surface of the heat conductive structure.

6. The light source module according to claim 1, wherein the sidewall and the bottom are substantially L-shaped.

7. The light source module according to claim 1, wherein the heat conductive structure comprises:
a plate body having a top surface, a bottom surface, and a first lateral surface, the top surface being opposite to the bottom surface, and the first lateral surface being adjacent to the top surface and the bottom surface;
a first extension portion extending from the top surface toward the first surface of the circuit board from an end of the plate body; and
a second extension portion extending from the bottom surface toward the first surface of the circuit board from the end of the plate body, wherein the second extension portion and the first extension portion is opposite to each other, the plate body, the first extension portion, and the second extension portion form an accommodating space for accommodating the bottom of the circuit board, the first extension portion is contacted the first surface and the second surface of the circuit board, the circuit board further comprises a third surface opposite to the second surface, and the second extension portion is contacted the third surface.

8. The light source module according to claim 7, further comprising a back plate, wherein the heat conductive structure is disposed on the back plate, and the back plate is contacted the plate body and the second extension portion of the heat conductive structure.

9. The light source module according to claim 1, wherein the heat conductive structure comprises:
a plate body; and
an extension portion extending toward the first surface of the circuit board from an end of the plate body, wherein
the extension portion and the plate body form an accommodating space for accommodating the bottom of the circuit board, and the extension portion is contacted the first surface and the second surface of the circuit board.

10. The light source module according to claim 9, further comprising a back plate, wherein the circuit board and the heat conductive structure are disposed on the back plate, the circuit board further comprises a third surface opposite to the second surface, and the back plate is contacted the third surface of the circuit board and the plate body of the heat conductive structure.

11. The light source module according to claim 9, wherein a thickness of the extension portion of the heat conductive structure is smaller than a thickness of the plate body of the heat conductive structure.

12. The light source module according to claim 1, wherein a distance between the light emitting element and the bottom of the circuit board is D, the light emitting element has a height of H, and D ranges between 2H and 4H.

13. The light source module according to claim 1, further comprising:
a supporting portion disposed on the light guide plate;
at least one optical film disposed between the supporting portion and the light guide plate; and
a reflective sheet disposed between the light guide plate and the heat conductive structure.

14. The light source module according to claim 1, wherein the circuit board comprises a metal base material and a circuit layer, and the metal base material comprises copper or aluminum.
